(19) United States
(12) Patent Application Publication
(10) Pub. No.: US 2013/0155232 A1
(43) Pub. Date: Jun. 20, 2013

(54) SURVEILLANCE CAMERA, SURVEILLANCE SYSTEM AND METHOD FOR CONFIGURING AN OR THE SURVEILLANCE CAMERA

(71) Applicant: Robert Bosch GmbH, Stuttgart (DE)

(72) Inventor: Rainer Bauereiss, Baiersdorf (DE)

(73) Assignee: ROBERT BOSCH GMBH, Stuttgart (DE)

(21) Appl. No.: 13/715,377

(22) Filed: Dec. 14, 2012

(30) Foreign Application Priority Data
Dec. 16, 2011 (DE) 10 2011 088 822.5

(51) Int. Cl. H04N 7/18

(52) U.S. Cl. CPC H04N 7/18
USPC 348/143

(57) ABSTRACT

A surveillance camera having at least one optical sensor for picking up an optical signal from the environment of the surveillance camera, wherein the optical signal comprises at least one coded data word. The surveillance camera has a configuration device for configuring the surveillance camera and a decoder device for decoding the coded data word. The configuration device is designed for utilizing the decoded data word for configuring the surveillance camera.

### BACKGROUND OF THE INVENTION

The invention relates to a surveillance camera having at least one optical sensor device for picking up an optical signal from the environment of the surveillance camera, wherein the optical signal can comprise at least one coded data word, and having a configuration device for configuring the surveillance camera. The invention also relates to a surveillance system comprising the surveillance camera and to a method for configuring the surveillance camera.

Surveillance cameras are used in most cases as stationary units in sensitive areas, the image data picked up by the surveillance cameras being conveyed, e.g., to surveillance centers where it is evaluated centrally. It is thus known, for example, to organize a multiplicity of surveillance cameras in a network, wherein the image data streams of the multiplicity of surveillance cameras are then conducted to the surveillance center and are displayed there on a monitor screen.

In the installation of such a surveillance camera network, considerable effort is expended for configuring the individual surveillance cameras at their respective installation site during the commissioning, apart from the mechanical integration effort for distributing the multiplicity of surveillance cameras in the planned surveillance area.

The printed document DE 10 2007 001 649 A1 relates, for example, to a method for self-calibration of a surveillance camera, wherein it is provided that a calibration of the surveillance camera is performed by observing a moving object in the surveillance area and lining it up with a motion model of the moving object.

### SUMMARY OF THE INVENTION

Within the scope of the invention, a surveillance camera is disclosed which is suitable and/or designed for monitoring a surveillance area. The surveillance area can be, e.g., a public square, a road intersection, a building, a storage hall, an inside room or the like.

The surveillance camera can be designed as a color camera or black/white camera. In possible embodiments, the surveillance camera is designed as a so-called 360-degree camera. It is also possible that the surveillance camera is constructed as a so-called PTZ (Pan-Tilt-Zoom) camera which can be moved under control. Particularly preferably, the surveillance camera has a network interface via which the surveillance camera can be integrated into a network in order to output image data or image data streams of the surveillance camera and/or to receive control data. The image data or image data streams, respectively, can be supplied, e.g., to a surveillance center.

The surveillance camera comprises at least one optical sensor device which is suitable and/or designed for picking up an optical signal from the environment of the surveillance camera. In particular, the optical signal is a light signal or an image signal.

Particularly preferably, the optical signal is in the visible range, that is to say at a wavelength of between 400 nm and 600 nm.

The optical signal can comprise at least one coded data word. The optical signal is thus a carrier of the at least one coded data word. In particular, the at least one coded data word is embedded in the optical signal. The uncoded or decoded data word can be represented particularly preferably in letters and/or numbers. Particularly preferably, the data word can be represented in binary form with a predeterminable word width or word length.

In addition, the surveillance camera comprises a configuration device for configuring the surveillance camera. Via the configuration device, parameters of the surveillance camera can be adjusted.

It is proposed in the context of the invention that the surveillance camera has a decoder device for decoding the coded data word, wherein the configuration device is designed for utilizing the decoded data word for configuring the surveillance camera, especially as configuration information for adjusting parameters of the surveillance camera. Thus, an alternative to the configuration of the surveillance camera is proposed by means of the invention.

It is one consideration of the invention that numerous adjustments of parameters of the surveillance camera must be carried out for the purpose of configuration at a surveillance camera, especially for the initial commissioning. However, since such a configuration is carried out only very rarely, often no or only rudimentary input options in the form of individual knobs, rocker switches or the like are provided at the surveillance cameras which have an almost confusing number of multiple functions. A configuration of the surveillance camera is complicated, in consequence, and often only possible with reference to the operating instructions.

By comparison, the optical sensor device is used as data interface in the invention in order to transmit in this manner at least one configuration information item in the form of the at least one coded data word, the surveillance camera being designed for decoding the decoded data word and utilizing the configuration information contained therein for configuring the surveillance camera.

In a preferred embodiment of the invention, the decoded data word comprises one or more of the following configuration information items in order to be able to adjust parameters of the surveillance camera:

In the case where the surveillance camera comprises a network interface, the configuration information can be designed as an IP address of the surveillance camera in a network. The IP addresses are often permanently specified in a network and must be input at the network user, in this case the surveillance camera. The coded data word comprises the IP address as configuration information so that, after the decoding, the IP address can be transferred to the configuration device and adjusted by the latter.

As an alternative or additionally, the configuration information can include a system ID. The coded data word comprises the system ID so that, after the decoding, the system ID can be transferred to the configuration device and adjusted by the latter. The surveillance camera is unambiguously identifiable in a surveillance system via the system ID. It is thus possible that the surveillance system is connected to the surveillance camera via a network. During the commissioning of the surveillance system, the network is scanned for the system IDs of the connected surveillance cameras by a management module. Knowing the system IDs, the surveillance cameras can then be selectively addressed by the management module so that other configuration information can be transmitted to the surveillance camera and adjusted by the configuration device.

In an alternative or a development, the configuration information comprises a control information item for adjusting the sharpness of focus. If the surveillance camera has an (electronic or optical) lens with range adjustment, this range adjustment can be transferred to the surveillance camera as control information via the at least one coded data word. It is thus possible, for example, that the surveillance camera is adjusted in a manner sharply focused on a near area or a far area.

A further option provides that the configuration information comprises a control information item for adjusting a zoom of the surveillance camera. The zoom can be formed electronically or optically and determines the section of image in the surveillance area.

It is a further option that the configuration information has a control information item for adjusting the alignment of a pan/tilt device. By means of the pan/tilt device, the surveillance camera can be aligned in the surveillance area.

In a further option, the configuration information comprises a control information item for adjusting an operating mode of the surveillance camera. It is thus possible that the surveillance camera has a night observation mode and a day observation mode, an IR illumination being activated in the case of the night observation mode, e.g. additionally, or another image sensor being used.

Other possible configuration information items comprise, for example, a diaphragm adjustment, an image recording repetition rate, an image resolution of the surveillance camera, etc.

In one possible embodiment, the optical sensor device is constructed as a brightness sensor, particularly as a photodiode or a photodiode array. Particularly preferably, the optical sensor device is implemented as an exclusively integrally measuring sensor device. Such brightness sensors are very inexpensive so that the implementation of this embodiment is very cost-effective. As has already been mentioned before, it is preferred if the wavelength of the optical signal is within the visible wavelength range, that is to say particularly with at least 70% of the energy received by the brightness sensor, preferably with at least 80% of the energy received by the brightness sensor, within a wavelength range of between 400 nm and 600 nm. In this case, the brightness sensor can also be used, apart from its function as optical interface, as a measuring instrument for the surveillance camera in order to determine the brightness in the environment of the surveillance camera and to transfer the brightness value to the surveillance camera for further processing.

In another embodiment of the invention, the optical sensor device is constructed as an image sensor in the surveillance camera. The image sensor is usually implemented as a two-dimensional sensor array onto which the image of the surveillance area is projected. In particular, the image sensor is constructed as an image chip, especially as a CCD chip or as a CMOS chip. This embodiment has the advantage that components of the surveillance camera, which must be mandatorily present in the surveillance camera for implementing its basic function, are used for receiving the coded data word. The image sensor thus implements a dual function, wherein it picks up the surveillance image in normal operation of the surveillance camera and, in a configuration mode, receives the optical signal and forwards it to the decoder device.

In one possible embodiment of the invention, the coding of the coded data word is implemented via form coding, the decoder device being designed for decoding the form-coded data word. For example, the coded data word is implemented as a binary image, especially as a one-dimensional bar code or as a two-dimensional bar code.

In another, very cost-effective variant, the coding of the coded data word is implemented via an intensity and/or color modulation of the optical signal. In the case of the intensity modulation, the optical signal can be implemented, for example, as a flashing sequence. In the case of the color modulation, the data word is coded by color changes. In particular, the coding can also be implemented by a combination of changing colors and changing intensities. In a very simple implementation of the invention, for example, the morse alphabet is used for coding the data word.

In particular in conjunction with the optical sensor device being formed as the image sensor in the surveillance camera, the coding via an intensity and/or color modulation has the advantage that at the instant of the transmission of the optical signal, the optical signal does not need to be projected sharply focused on the image sensor but a detailless or unsharply focused image also carries the coded data word as information.

A further subject matter of the invention relates to a surveillance system which has at least one surveillance camera as has been described before or according to one of the preceding claims. Furthermore, the surveillance system comprises a transmitting device for generating the optical signal.

The transmitting device is constructed preferably as a manually operated data processing device and can have in specific embodiments a form of construction as is known currently as Smartphone, pocket PC, tablet PC, PDA (Personal Digital Assistant).

Particularly preferably, the manually operated data processing device has a monitor or display, the optical signal being generated by the monitor.

In an implementation of the invention, it is possible that, e.g., the data word is displayed form-coded, e.g. as binary image, bar code, etc., on the monitor. By recording the monitor pictorially, the form-coded data word is transferred to the surveillance camera via the optical signal and can be decoded there. Coding of the data word can also take place by displaying the data word legibly for the person on the monitor, then transferring it as optical signal in a coded manner to the surveillance camera and decoding it there, e.g. by means of character recognition.

As an alternative or additionally, it is possible that the coded data word is coded in the optical signal by an intensity modulation, e.g. a blinking or a blinking sequence of the monitor, preferably of the entire monitor. It is possible, e.g., to hold the manually operated data processing device directly in front of the lens of the surveillance camera and to start the intensity modulation, especially the blinking sequence. Using the decoder device, the surveillance camera decodes the coded data word contained in the optical signal of the intensity modulation, especially of the blinking sequence, and configures the surveillance camera correspondingly. It can be provided optionally that the successful data transmission is signaled, e.g., by an LED. Furthermore, it can be provided optionally that in order to protect the transmission of the coded data word, a checksum of the data word is also transmitted which can be recalculated.

In a preferred embodiment, the manually operated data processing device comprises an “App” which is designed for coding the data word by driving the monitor. For example, the data word is input into the data processing device by means of a keyboard or another input aid of the data processing device, coded by the latter and then transmitted via the monitor as optical signal to the surveillance camera. It is generally preferred that the data word is input or can be input via a keyboard.

In a development of the invention, it can be provided that the surveillance system has a multiplicity of, preferably more than 10, preferably more than 30, surveillance cameras, wherein the transmitting device, especially the manually operated data processing device, can be used for configuring all surveillance cameras. Thus, for example, a user can go from one surveillance camera to the next one and configure it in the manner described by means of the transmitting device or the manually operated data processing device, respectively.

In a possible development of the invention, the surveillance system comprises a server, wherein the server can be connected and/or is connected with respect to signals to the manually operated data processing device via a network. For example, the manually operated data processing device has a WLAN interface via which a connection is made to the server. The server provides at least one configuration information item, especially an IP address, for the manually operated data processing device, wherein the manually operated data processing device is designed for transmitting the at least one configuration information item to the surveillance camera as coded data word.

A further subject matter of the invention relates to a method for transmitting at least one data word to a surveillance camera, wherein the data word has at least one configuration information item for configuring the surveillance camera. Especially preferably, the surveillance camera is designed as previously described or, respectively, in accordance with one of the preceding claims. The data word is embedded into an optical signal as carrier and cablelessly transmitted to the surveillance camera. The surveillance camera receives the optical signal with the embedded coded data word, decodes the latter and utilizes the decoded data word as configuration information for configuring the surveillance camera.

### BRIEF DESCRIPTION OF THE DRAWINGS

Further features, advantages and effects of the invention are obtained from the subsequent description of a preferred exemplary embodiment of the invention and the attached figures, in which:

FIG. 1 shows a schematic block diagram of a surveillance system comprising a surveillance camera as one exemplary embodiment of the invention;

FIGS. 2a, b show, also as a block diagram, two possible embodiments of the surveillance camera in FIG. 1;

FIGS. 3a, b show, also as a block diagram, two possible embodiments of the transmitting device in FIG. 1;

FIG. 4 shows the surveillance system in FIG. 1 as a block diagram with further components.

### DETAILED DESCRIPTION

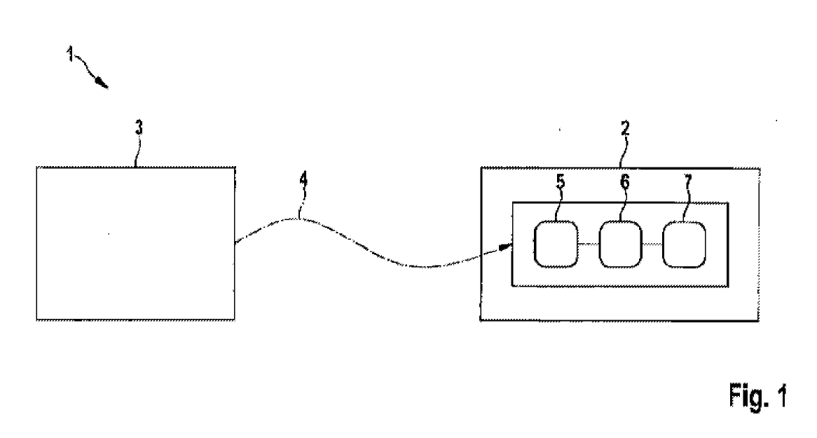

FIG. 1 shows in a schematic block diagram a surveillance system 1 which comprises at least one surveillance camera 2 and a transmitting device 3. The surveillance camera 2 is used for the surveillance of public or private areas and is usually mounted on a wall or on a mast. The surveillance camera 2 can be constructed, for example, as a PTZ (Pan-Tilt-Zoom) camera or as a 360-degree camera.

During an installation, maintenance or revision, it is often necessary to configure the surveillance camera 2. For example, configurations with regard to the IP address, the adjustment of the sharpness of focus, the adjustment of the zoom, the adjustment of the alignment of a pan/tilt device, an operating mode, etc. can be configured in a surveillance camera 2.

In the case of the surveillance camera 2, at least one configuration information item is transmitted cablelessly via an optical signal 4. In the optical signal 4, a coded data word is embedded which carries the at least one configuration information item. For picking up the optical signal, the surveillance camera 2 has a sensor device 5 which receives the optical signal 4 and subsequently transfers it to a decoder device 6, in which the data word is decoded from the optical signal 4, and forwards it as a configuration information item to a configuration device 7 of the surveillance camera 2 which configures the surveillance camera 2 in accordance with the configuration information item. Due to the signal transmission path of the configuration information as coded data word in the optical signal 4, external input options can be omitted or limited to a minimum.

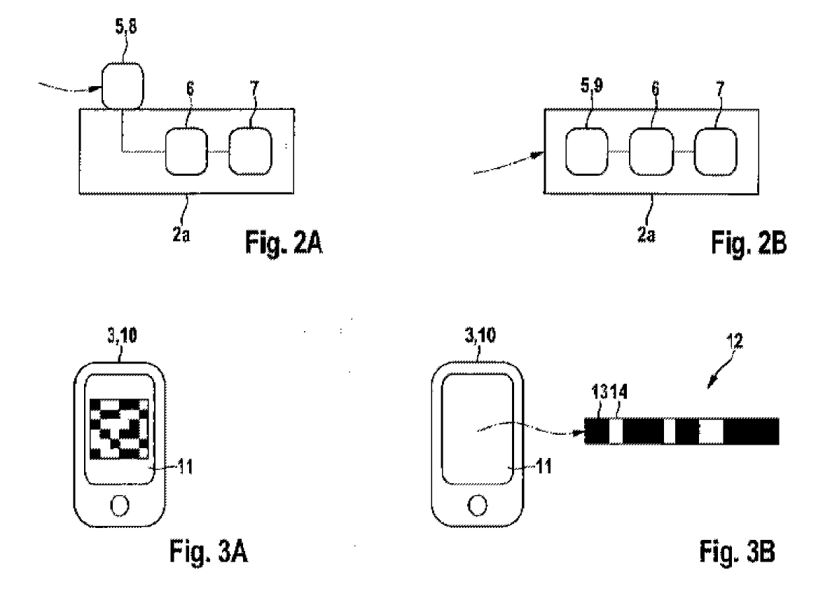

FIGS. 2a, b show two possible exemplary embodiments of the surveillance camera 2. In FIG. 2a, the sensor device 5 is constructed as a brightness sensor 8 which, e.g., is implemented as an integrally measuring sensor. For example, the brightness sensor 8 can be constructed as a photodiode with a corresponding amplifier device. This variant of an embodiment can be used if the coded data word is embedded as intensity modulation in the optical signal 4. For example, the optical signal 4 can be designed as a blinking sequence, wherein, in the simplest case, a Morse code could be used for transmitting the data word in a coded manner.

In FIG. 2b, the sensor device is constructed as an image sensor 9 which is also used for picking up the image information from the surveillance environment of the surveillance camera 2. In a configuration mode, the optical signals 4 received by the image sensor 9 are not interpreted as surveillance data but are forwarded to the decoder device 6 for decoding the coded data word.

For the exemplary embodiment of FIG. 2b in which the signal device 5 is constructed as the image sensor 9, the optical signal can be form-coded. Thus, it is possible, for example, that the surveillance camera 2 picks up a binary code, a bar code, etc. optically and forwards it via the image sensor 9 to the decoder device where it is decoded and the configuration information item contained is forwarded to the configuration device 7.

FIG. 3a shows a first exemplary embodiment of the transmitting device 3, the transmitting device 3 being constructed as a Smartphone 10 which has a monitor 11 on which the binary code, bar code, etc. is displayed. In the combination of the surveillance camera 2 from FIG. 2b and the transmitting device 3 from FIG. 3a, the monitor 11 is filmed by the surveillance camera 2 and the image is forwarded to the decoder device 6 for decoding.

In FIG. 3b, the Smartphone 10 is shown again as transmitting device 3 but the coded data word is output by the monitor 11 by means of intensity modulation of the optical signal 4. Such intensity modulation 12 is shown highly diagrammatically in FIG. 3b, the black areas 13 representing a maximum of intensity and the white areas 14 a minimum of intensity. The optical signal 4 can be generated, for example, by switching the illumination of the monitor 11 on and off. It is also possible that only the brightness is changed on the monitor 11 or even different colors are displayed for coding the data word in the optical signal 4. Combining the Smartphone 10 from FIG. 3b with the surveillance camera from FIG. 2b has the advantage that the monitor 11 of the Smartphone 10 does not even have to be focused sharply by the surveillance camera 2 since the configuration information item contained in the intensity modulation 12 can also be evaluated if the lens of the surveillance camera 2 is unfocused. This allows a surveillance camera 2 to be configured “out of the box” with the assistance of the transmitting device 3 or the Smartphone 10, respectively.

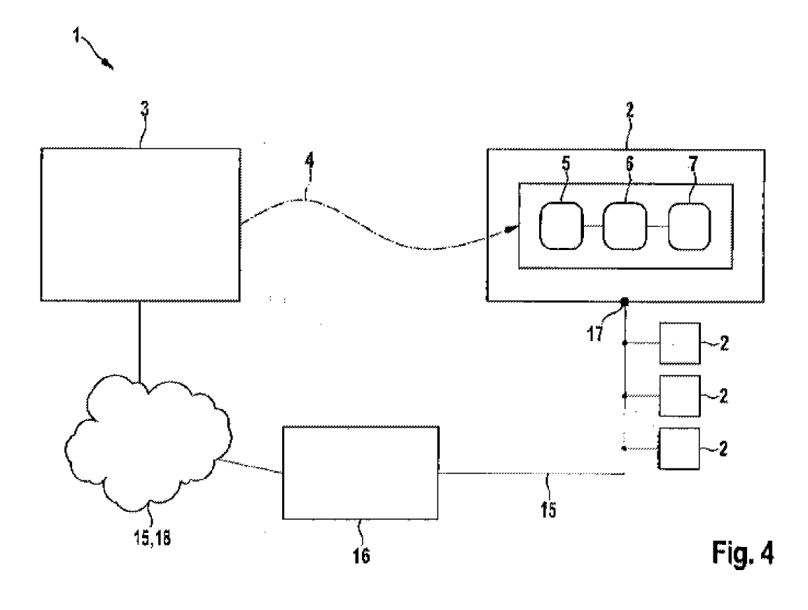

The surveillance system 1 is shown again in FIG. 4 but it is connected to a server 16 via a network 15. For this purpose, the surveillance camera 2 has a network interface 17. Apart from the surveillance camera 2, the surveillance system 1 can also have further constructionally identical surveillance cameras 2 which are also coupled with the server 16 via the network 15. The server 16 is coupled with the transmitting device 3 with respect to signals. For example, the coupling can be made via a WLAN 18 or the same network 15.

During the configuration of the surveillance camera 2, the transmitting device 3 requests configuration information for the surveillance camera 2 from the server 16, converts it as coded data words in the optical signal 4 and transmits the configuration information to the surveillance camera 2.

For example, the server 16 can issue an IP address which is transferred as configuration information to the surveillance camera 2 via the transmitting device 3 and the optical signal 4. The surveillance camera 2 evaluates this configuration information and can optionally signal the successful transmission by an LED. From this point onward, the surveillance camera 2 can be reached without further intermediate steps via the network 15 so that an ongoing configuration with the necessity of transmitting greater sets of parameters can now take place via the network 15.

1. A surveillance camera comprising:
at least one optical sensor for sensing an optical signal from the environment of the surveillance camera, wherein the optical signal comprises at least one coded data word,
a configuration device for configuring the surveillance camera, and
a decoder device for decoding the coded data word, wherein the configuration device is designed for utilizing the decoded data word for configuring the surveillance camera.

2. The surveillance camera according to claim 1, wherein the decoded data word comprises one or more of the following configuration information items:
IP address of the surveillance camera;
System ID of the surveillance camera;
Control information for adjusting the sharpness of focus;
Control information for adjusting the zoom;
Control information for adjusting the alignment of a pan/tilt device;
Control information for adjusting an operating mode.

3. The surveillance camera according to claim 1, wherein the optical sensor device comprises a brightness sensor.

4. The surveillance camera according to claim 1, characterized in that the optical sensor device is constructed as an image sensor in the surveillance camera.

5. The surveillance camera according to claim 4, characterized in that the coding of the coded data word is implemented via form coding.

6. The surveillance camera according to claim 1, wherein the coding of the coded data word is implemented via an intensity and/or color modulation of the optical signal.

7. A surveillance system comprising:
at least one surveillance camera according to claim 1, and
a transmitting device for generating the optical signal, wherein the transmitting device comprises a manually operated data processing device.

8. The surveillance system according to claim 7, wherein the manually operated data processing device has a monitor, and the manually operated data processing device is designed for generating the optical signal by the monitor.

9. The surveillance system according to claim 7, wherein the manually operated data processing device is designed for embedding the coded word in the optical signal via a blinking sequence of the monitor.

10. The surveillance system according to claim 7, wherein the manually operated data processing device has an App which is designed for coding the data word by driving the monitor.

11. The surveillance system according to claim 7, further comprising a server, wherein the server can be connected with respect to signals to the manually operated data processing device via a network, wherein the server provides at least one configuration information item of the surveillance camera for the manually operated data processing device, wherein the manually operated data processing device is designed for transmitting the at least one configuration information item to the surveillance camera as a coded data word via an optical signal.

12. A method for transmitting at least one data word to a surveillance camera, wherein the data word has at least one configuration information item for configuring the surveillance camera, wherein the data word is transmitted as a coded data word to the surveillance camera in an optical signals carrier and wherein the surveillance camera decodes the coded data word and utilizes the decoded data word for configuring the surveillance camera.
